(19) United States
(12) Patent Application Publication
(10) Pub. No.: US 2024/0083816 A1
(43) Pub. Date: Mar. 14, 2024

(54) Ceramic Sol-Gel Coating (Grouting)

(71) Applicant: CO2 Convert, LLC, Houston, TX (US)

(72) Inventors: Robert Howard, Houston, TX (US); Sari Frank, Houston, TX (US)

(21) Appl. No.: 18/465,809

(22) Filed: Sep. 12, 2023

Related U.S. Application Data
(60) Provisional application No. 63/375,340, filed on Sep. 12, 2022.

(51) Int. Cl. C04B 28/00; C04B 12/00

(52) U.S. Cl. CPC C04B 28/005; C04B 12/005; C04B 2111/00017

(57) ABSTRACT

The present invention is a ceramic sol-gel coating system. A sol-gel solution is applied to a tilled roadbed. The roadbed is formed, then a cross-linker is applied. The roadbed is then rolled. The sol-gel solution and cross-linker react to form a ceramic sol-gel coating around the road aggregate. The coating reacts with carbon dioxide in the air to form calcium carbonate rock, capturing the carbon dioxide directly from the air.

### FIELD OF THE INVENTION

The present invention relates generally to roadway construction. More specifically, the present invention relates to ceramic sol-gel solutions that bind road materials.

### BACKGROUND OF THE INVENTION

Sol-gel is a process for producing solid materials. A liquid solution containing solid particles is transformed into a gel. Grout refers to a dense ceramic sol-gel solution that is used to fill gaps or reinforce existing structures. Grout generally consists of a mixture of water, cement, and sand. In road construction, grout is used to bind the road aggregate.

It is an objective of the present invention to provide a ceramic sol-gel grouting system that is applied to gravel roads, unimproved dirt roads, and sand roads. It is a further objective of the present invention to provide a ceramic sol-gel grouting system that will permanently grout and bind the road aggregate, dirt, dust, soil, crushed concrete, and recycled asphalt.

### SUMMARY OF THE INVENTION

The present invention is a ceramic sol-gel grouting system. A dirt roadbed is tilled. A sol-gel coating is sprayed to the tilled roadbed. The crown of the roadbed is formed. A cross-linker is sprayed on the road. The roadbed is rolled. The sol-gel solution and cross-linker react to form a ceramic coating around the road aggregate. The ceramic coating forms a durable, permanent grout around the road aggregate. The ceramic coating reacts with carbon dioxide in the air to form calcium carbonate rock, capturing the carbon dioxide from the air.

### BRIEF DESCRIPTION OF THE DRAWINGS

FIG. 1 is a block diagram of Embodiment 1 of the present invention.

FIG. 2 is a flowchart showing the application of Embodiment 1 of the present invention.

### DETAILED DESCRIPTION OF THE INVENTION

All illustrations of the drawings are for the purpose of describing selected versions of the present invention and are not intended to limit the scope of the present invention.

The present invention comprises a ceramic sol-gel (grouting) system. The ceramic sol-gel system is applied to gravel roads, unimproved dirt roads, or sand roads. The ceramic sol-gel system will permanently grout and bind the road aggregate, dirt, dust, crushed concrete, and recycled asphalt. The ceramic sol-gel system produces a nontoxic and non-polluting ceramic grouted road surface. The ceramic sol-gel system produces a hard, durable, permanent, non-slippery, and granular road surface. The ceramic-grouted road surface provides roadbed stability, surface durability, as well as water shedding. The grout shell surface (Sol-Gel) also provides direct air capture of carbon dioxide (CO2) and will convert the CO2 to calcium carbonate “rock.”

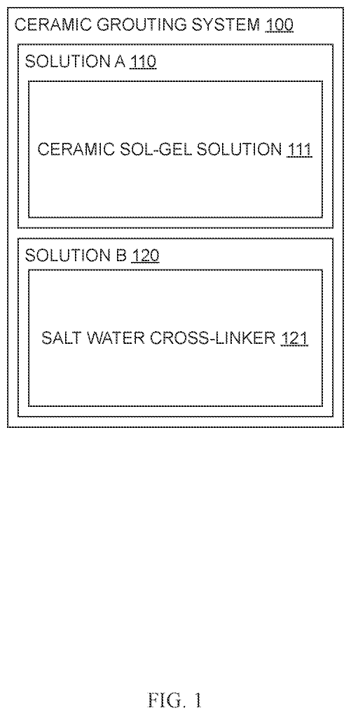

Referring to FIG. 1, Embodiment 1 of the present invention comprises a ceramic sol-gel coating system 100. The ceramic sol-gel system is comprised of Solution A 110 and Solution B 120. Solution A 110 is comprised of a 35% to 65% ceramic sol-gel in water solution 111. Solution B 120 is comprised of a saltwater cross-linker 121.

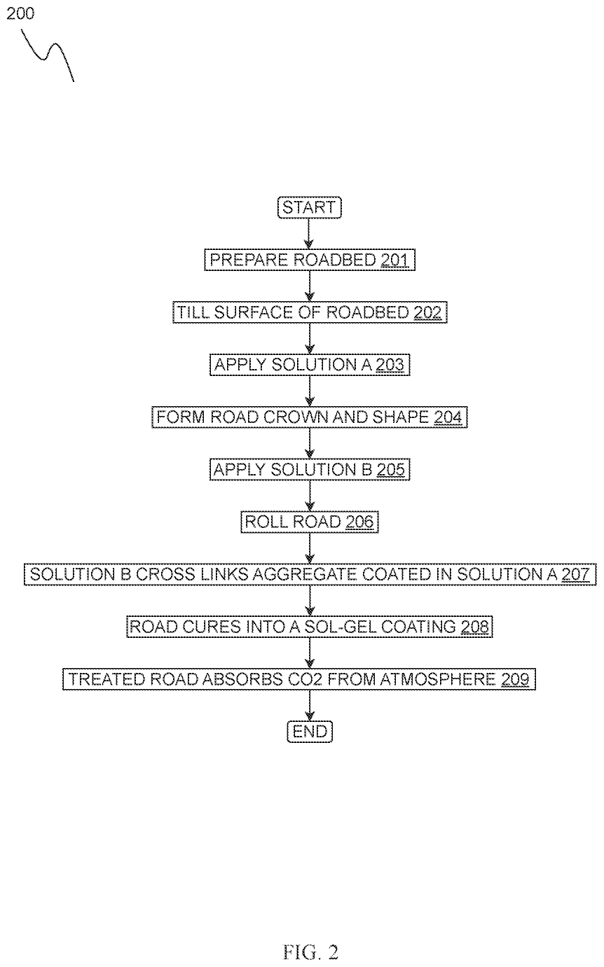

Referring to FIG. 2, Embodiment 1 of the present invention is applied to a roadway through the process described by flowchart 200.

At step 201, a new or existing roadbed is prepared for sol-gel application. For example, an aggregate material may be laid in the intended location of the road.

At step 202, the top surface of the roadbed is tilled. For example, the top four inches of the roadbed is tilled to loosen the aggregate material. Tilling the roadbed allows Solution A 110 to fully drape, wrap, and envelope the roadbed aggregate and dust.

At step 203, a first solution, Solution A 110, is applied to the roadbed. Solution A 110 is sprayed onto the prepared roadbed. The Solution A 110 envelops the pieces of the aggregate material of the roadbed.

At step 204, the crown and shape of the road is formed. The crown of the road is a raised section, typically located at the center of the road.

At step 205, a second solution, Solution B 120, is applied. The Solution B 120 is sprayed onto the freshly formed road surface.

At step 206, the road is rolled. A road roller is used to compress the aggregate of the road.

At step 207, Solution B 120 cross links the coated aggregate. The Solution B 120 instantaneously cross links the Solution A 110 coating the road aggregate to form a hard, durable, permanent, and granular road surface.

At step 208, the road cures into a sol-gel coating. As Solution B 120 reacts with the Solution A 110, the mixture cures into a granular grouted road surface. The cured mixture forms a ceramic coating.

At step 209, the treaded road absorbs carbon dioxide (CO2) directly from the atmosphere. The CO2 is captured through direct air capture (DAC). As the sol-gel road surface cures, the ceramic grout forms and cures on the road. The cross-linked sol-gel is reactive with CO2 gas in the atmosphere. The surface of the grouted road will provide direct air capture and conversion of CO2, which hardens the treated road surface. The hardened road surface reacts with CO2 in the air and converts the CO2 to calcium carbonate rock. The reactant surface of the ceramic sol-gel coating will absorb and hold a portion of its weight in captured CO2. The coated road aggregate will absorb approximately 10 tons of CO2 per lane mile.

Although the invention has been explained in relation to its preferred embodiment, it is to be understood that many other possible modifications and variations can be made without departing from the spirit and scope of the invention as hereinafter claimed. It is to be understood that the steps in the present invention may be performed in any order, and the order of the steps may be modified without departing from the spirit and scope of the invention hereinafter claimed. It is to be understood that any steps in the present invention may be repeated without departing from the spirit and scope of the invention hereinafter claimed.

What is claimed is:

1. A method for ceramic sol-gel coating, comprising:
preparing a roadbed;
applying a first solution to the roadbed;
forming the roadbed;
applying a second solution to the roadbed;
rolling the roadbed; and
combining the first solution and the second solution in a chemical reaction.

2. The method for ceramic sol-gel coating of claim 1, wherein combining the first solution and the second solution in the chemical reaction further comprises the second solution cross-linking the first solution.

3. The method for ceramic sol-gel coating of claim 2, wherein combining the first solution and the second solution in a chemical reaction further comprises forming a ceramic coating on the roadbed.

4. The method for ceramic sol-gel coating of claim 1, wherein combining the first solution and the second solution in the chemical reaction further comprises capturing carbon dioxide.

5. The method for ceramic sol-gel coating of claim 1, wherein preparing the roadbed further comprises tilling the roadbed.

6. The method for ceramic sol-gel coating of claim 5, wherein preparing the roadbed further comprises laying the roadbed.

7. The method for ceramic sol-gel coating of claim 1, wherein applying the first solution to the roadbed further comprises spraying the first solution onto the roadbed.

8. The method for ceramic sol-gel coating of claim 1, wherein applying the second solution to the roadbed further comprises spraying the second solution onto the roadbed.

9. The method for ceramic sol-gel coating of claim 1, wherein forming the roadbed further comprises forming a crown on the roadbed.

10. A method for ceramic sol-gel coating, comprising:
tilling a roadbed;
spraying a first solution onto the roadbed;
forming the roadbed;
spraying a second solution onto the roadbed;
rolling the roadbed; and
combining the first solution and the second solution in a chemical reaction.

11. The method for ceramic sol-gel coating of claim 10, wherein combining the first solution and the second solution in the chemical reaction further comprises the second solution cross-linking the first solution.

12. The method for ceramic sol-gel coating of claim 11, wherein combining the first solution and the second solution in a chemical reaction further comprises forming a ceramic coating on the roadbed.

13. The method for ceramic sol-gel coating of claim 10, wherein combining the first solution and the second solution in the chemical reaction further comprises capturing carbon dioxide.

14. The method for ceramic sol-gel coating of claim 10, further comprising laying the roadbed.

15. The method for ceramic sol-gel coating of claim 10, wherein forming the roadbed further comprises forming a crown on the roadbed.

16. A method for ceramic sol-gel coating, comprising:
laying a roadbed;
tilling the roadbed;
spraying a sol-gel solution onto the roadbed;
forming a crown on the roadbed;
spraying a cross-linker solution onto the roadbed;
rolling the roadbed; and
the cross-linker solution cross-linking the sol-gel solution.

17. The method for ceramic sol-gel coating of claim 16, further comprising capturing carbon dioxide.

18. The method for ceramic sol-gel coating of claim 16, further comprising forming a ceramic coating on the roadbed.
